(19) United States
(12) Patent Application Publication
(10) Pub. No.: US 2005/0213609 A1
(43) Pub. Date: Sep. 29, 2005

(54) Providing internet users with presence information about telephone lines in the public switched telephone network

(76) Inventors: Alec Brusilovsky, Naperville, IL (US); Vijay K. Gurbani, Lisle, IL (US); Xian He Sun, Darien, IL (US)

Correspondence Address: PATTI & BRILL, ONE NORTH LASALLE STREET, 44TH FLOOR, CHICAGO, IL, 60602, US

(21) Appl. No.: 10/808,913

(22) Filed: Mar. 25, 2004

(51) Int. Cl. H04J 3/24

(52) U.S. Cl. 370/474; 370/352

(57) ABSTRACT

Presence state information is made available to an Internet user about a public switched telephone network (PSTN) subscriber utilizing a first terminal that does not have direct Internet communications capability. First messages from the PSTN switch providing communication services to the PSTN subscriber are received. The first messages contain call event information. The presence state of the PSTN subscriber is determined based on the call event information. A second message is transmitted using Internet protocol to the Internet terminal of the Internet user, the second message containing the presence state information about the PSTN subscriber.

### CROSS-REFERENCE TO RELATED APPLICATION

This application claims priority on U.S. patent application Ser. No. 09/368,985 which was filed Aug. 5, 1999.

### BACKGROUND

This invention generally relates to facilitating communication services between the public switched telephone network (PSTN) and the public Internet or a managed Internet Protocol (IP) network (referred to herein as the Internet). It more specifically relates to providing presence state information to Internet based users concerning the state of a telephone line in the PSTN.

The PSTN provides dependable wireline and wireless communications for subscribers. A variety of services such as call waiting, incoming caller identification, conference calling and call forwarding are supported. Most if not all of these services are also available for wireless, e.g. cellular, subscribers. Such services for both the wireline and wireless subscribers are supported by telecommunication switches in the PSTN that are interconnected by the signaling system 7 (SS7) network that supports command and control signaling among the switches and intelligent peripherals such as a service control point.

The responsible originating and terminating switches in the PSTN must be able to determine the status of the supported subscriber telephone lines in order to provide such services. For example, the status of the line of a called party must be determined to be off-hook before a call waiting signal is applied to the line to indicate another incoming call. The call model implemented by the terminating and originating switches in conjunction with the Intelligent Network (IN) elements requires line status information be available and that events associated with the line be monitored for proper call processing. While this event monitoring and line status information is available to the originating/terminating switch and on a more limited basis to associated intelligent peripherals within the PSTN, such information is not available outside of the PSTN.

Various applications provide Internet users with the ability to maintain a list of people that is periodically updated to provide the Internet user with the “presence” of each member of the list. As used herein, presence refers to the capability of a system to determine the communication status of a selected user, that is, the ability to communicate to or with a selected user. For example, America Online provides Internet users with an Instant Messenger application that maintains a list of the user's selected “buddies”. This application also provides the user with an indication of the presence of each buddy where the presence is updated periodically. This service is commonly employed by Internet users to transmit instant messages among each other where all of the users are a member of a common group of buddies. Although wireline connected Internet access is most commonly used for such messaging, a wireless connection to the Internet such as provided by a wireless modem, personal digital assistant (PDA), or a 2.5 generation (G) or higher Internet enabled cellular phone can also be utilized.

As the number of knowledgeable Internet users continues to rapidly increase, there is becoming an increasing desire to have access to the presence of people with whom the Internet user may desire communications. This is of course already provided by various applications for people logged on to the Internet, either by a wireline connection or a wireless connection. However, an Internet user does not have access to the same level of information, i.e. presence, for people utilizing a PSTN communication device, e.g. a POTS telephone, which is not Internet enabled, or wireless phones not connected to the Internet. Thus, there exists a need to be able to provide Internet users with the presence of selected PSTN subscribers that utilize communication devices that are not Internet enabled.

### SUMMARY OF THE INVENTION

It is an object of the present invention to provide a solution to this need.

In accordance with an embodiment of the present invention, presence state information is made available to an Internet user about a public switched telephone network (PSTN) subscriber utilizing a first terminal that does not have direct Internet communications capability. First messages from the PSTN switch providing communication services to the PSTN subscriber are received. The first messages contain call event information concerning the line used by the PSTN subscriber. The presence state of the PSTN subscriber is determined based on the call event information. A second message is transmitted using Internet protocol to the Internet terminal of the Internet user, the second message containing the presence state information about the PSTN subscriber.

### BRIEF DESCRIPTION OF THE DRAWINGS

FIG. 1 is a block diagram of a telecommunication network that incorporates an embodiment of the present invention.

FIG. 2 is a block diagram of the intelligent node as shown in FIG. 1.

FIG. 3 is a representation of a displayed screen of presence information on an Internet user's communication terminal in accordance with an embodiment of the present invention.

FIG. 4 is similar to FIG. 3 except that it illustrates different presence information reflecting a change in the presence status of members of the illustrated list in accordance with an embodiment of the present invention.

FIG. 5 is a flow diagram illustrating steps taken by the intelligent node as shown in FIG. 1 in accordance with an embodiment of a method of the present invention.

FIG. 6 is a flow diagram illustrating steps taken by the Internet user's communication terminal to provide the Internet user with presence information in accordance with an embodiment of a method of the present invention.

### DETAILED DESCRIPTION

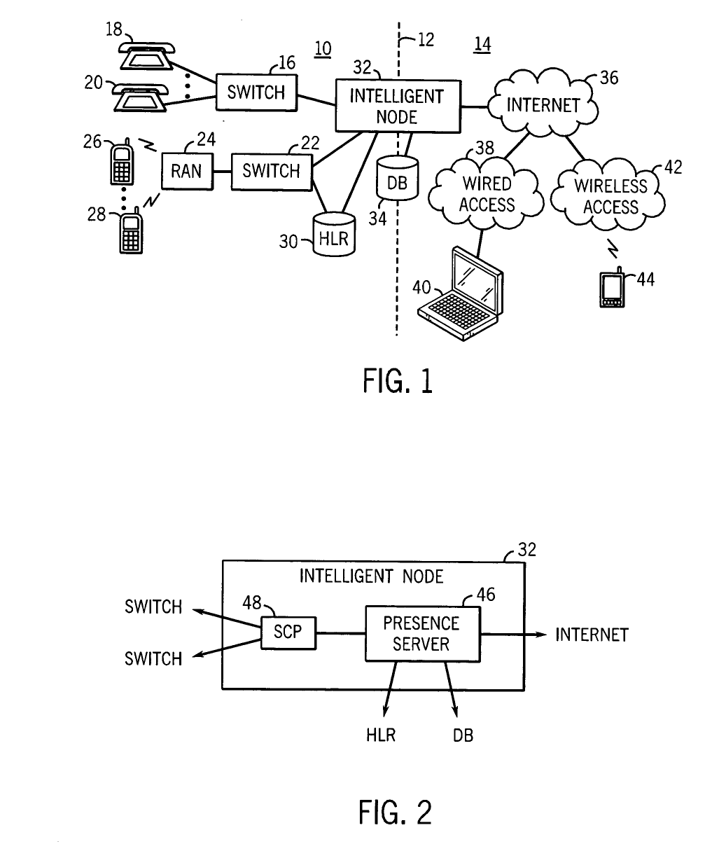

FIG. 1 illustrates an exemplary telecommunication network that includes at least a portion of the PSTN 10 located to the left of vertical line 12 and at least a portion of the Internet network 14 to the right of line 12. A telecommunication switch 16 such as a 5ESS switch available from Lucent Technologies Inc. provides wireline telecommunication services to subscribers via consumer premises equipment, e.g. telephones, represented by telephones 18 and 20. A telecommunication switch 22 supports wireless communications in cooperation with radio access nodes (RAN) represented by exemplary RAN 24. Subscribers utilize wireless terminals, e.g. cellular telephones, represented by cellular telephones 26 and 28 for wireless communications as supported by switch 22. A home location register (HLR) 30 is connected to switch 22 and facilitates well-known support services for wireless communications including registration, authentication and location for wireless subscribers.

An intelligent node 32 and its associated database 34 support communications services that require an interface between the PSTN 10 and the Internet network 14, and hence are shown as residing at the boundary of these two networks. The intelligent node 32 is coupled to switches 16 and 22 as well as HLR 30 of the PSTN network 10. It is also connected to at least a portion of the Internet as represented by Internet system 36. The intelligent node 32 enables Internet users to obtain presence information for wireline and wireless subscribers of the PSTN as will be described below.

The Internet system 36 is connected to a wired access network 38 that supports wireline Internet communication services for subscribers using wired communication terminals as represented by computer 40. As used herein a “wireline” Internet communication link includes all forms transmission lines including optical fiber cables. The Internet system 36 is also connected to a wireless access network 42 that supports wireless Internet communication services for subscribers using wireless communication terminals as represented by wireless PDA 44. As used herein a “wireless” communication terminal includes all forms of wireless communication devices such as computers with wireless modems and Internet enabled cellular telephones.

FIG. 2 illustrates an exemplary intelligent node 32 that includes a presence server 46 connected to a service control point (SCP) 48. The presence server 46 may consist of a conventional server controlled by one or more microprocessors operating under the control of stored program control instructions (software and/or firmware). Functions performed by the intelligent node 32 will be described in greater detail below with regard to flow diagram 5. The presence server 46 is connected to the SCP 48 that is in turn connected to switches 16 and 22. The SCP obtains information from the switches in a PSTN compatible protocol about the status of call events associated with selected PSTN subscribers, i.e. the status of selected subscribers' telephone lines for wireline subscribers and the status of selected subscribers' wireless communication channels for wireless subscribers. As used herein “telephone line” refers to both a conventional wire telephone line and a wireless channel used to provide communications to subscribers. The SCP 48 relays such event information to the presence server 46 that processes the information and determines whether a change in the presence of the corresponding PSTN subscriber has occurred. If a change in presence is detected for a PSTN subscriber for whom presence is being monitored by an Internet user, e.g. PSTN subscribers on a Pal list of an Internet user, the presence server 46 will transmit a presence update message to the corresponding Internet user. The presence server 46 is also connected to database 34 that stores registration and authentication information for Internet users that subscribe for PSTN presence update service as well as records relating to presence and PSTN telephone lines being monitored for presence. The presence server 46 is also connected to the HLR in order to obtain information about wireless PSTN subscribers that can be utilized to determine presence such as whether a wireless terminal is currently active and registered. The presence server processes this information in addition to call status information provided by switch 22 to determine the present state for wireless PSTN subscribers.

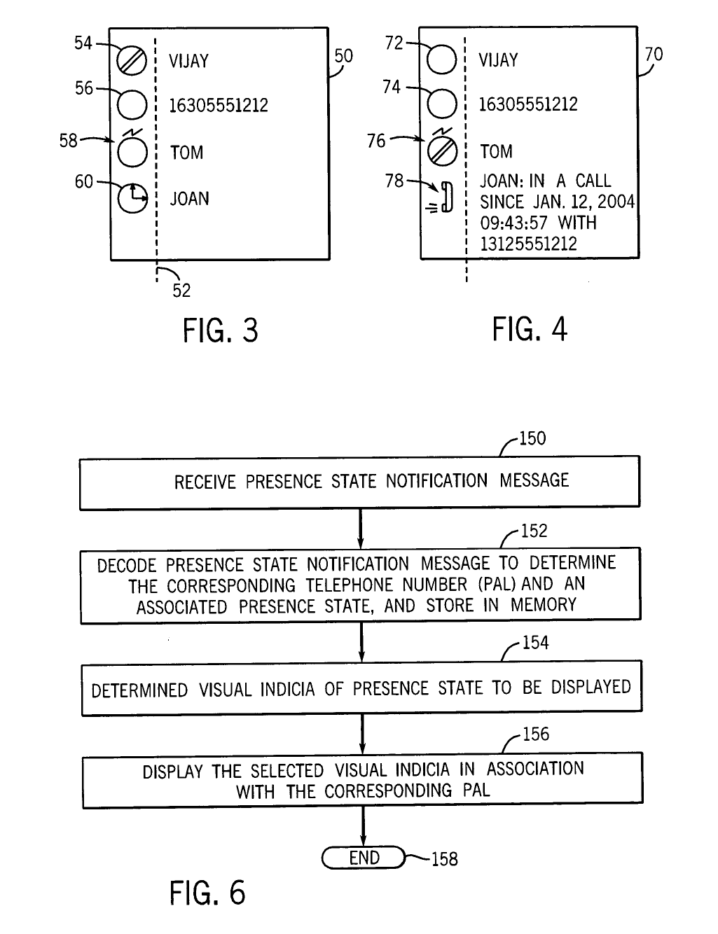

FIG. 3 shows an exemplary screen 50 of a display of an Internet user's communication terminal such as PDA 44 in which the presence of Pals using PSTN communications equipment is displayed in accordance with an embodiment of the present invention. Vertical line 52 divides the exemplary screen 50 into left and right columns wherein the left column displays indicia representing a presence state for a corresponding Pal indicated by the label in the right column of the same row. The indicia 56, an open circle, indicates that the corresponding Pal, identified by a telephone number, is available for communications. The indicia 54, a circle with two diagonal lines through it, indicates that the corresponding Pal, Vijay, is not available for communications. The indicia 58, an open circle with a lightning bolt above it, indicates that the corresponding Pal, Tom, is available for communications; the lightning bolt signifying that the communications available with Tom is by a wireless PSTN communication path. An example of conditions giving rise to this presence state would be that Tom is utilizing a PSTN cellular telephone and that the telephone is ON and registered for wireless communications. The indicia 60, a clock face, indicates that the corresponding Pal, Joan, was last determined to be available for communications at the time represented by the clock face. For example, a telephone call involving the PSTN telephone line normally utilized by Joan may have been completed at the indicated time, and no further call related events have occurred for the telephone line since then. Alternatively, the elapsed time since the last completed call event could be displayed.

It will be understood that the concept of “presence” of a person for communications is a misnomer. The presence being sensed is communication activity associated with a PSTN telephone line or particular wireless telephone. If the Pal is the only person who normally utilizes a particular PSTN telephone line or wireless telephone, then it is highly probable that the presence of that Pal for communications will be accurately reflected in accordance with an embodiment of the present invention. However, if a Pal is associated with a PSTN telephone line that is commonly shared among several people, then the probability of the presence of the specific Pal for communications by the shared PSTN telephone line is considerably less. A buddy list showing the presence of Internet users has the advantage that a personal identification number (PIN) or unique login is used to distinguish and verify each Pal. If the PSTN or an intelligent network service associated with the PSTN provides a personal identification, then this information could be utilized to increase the probability that the presence associated with a PSTN telephone line or wireless telephone actually corresponds with the specific person, i.e. the Pal identified on the list.

FIG. 4 shows an exemplary screen 70 on the same Internet user's display as shown in FIG. 3. The screen 70 represents the same screen 50 but at a later time during which the present state of the Pals may have changed. Indicia 72, an open circle, indicates that Pal, Vijay, is now available for communications. The indicia 74, an open circle, indicates that the Pal identified by the telephone number remains available for communications. The indicia 76, an open circle with two diagonal lines across it with a lightning bolt above, indicates that the Pal, Tom, is no longer available for communications using his wireless telephone. The indicia 78, a telephone handset with voice indicated, indicates that the Pal, Joan, is currently engaged in a call using the associated PSTN telephone line. It will be noted that in this case the right hand column containing the label associated with indicia 78 has also changed to reflect information concerning the ongoing telephone call indicating that Joan has been, in a call since Jan. 12, 2004 at 09:43:57 (9:43 AM and 57 seconds) with another PSTN party with telephone number 13125551212. Comparing FIG. 3 with FIG. 4 it will be seen that the associated presence states have been updated with the passage of time to reflect different presence states.

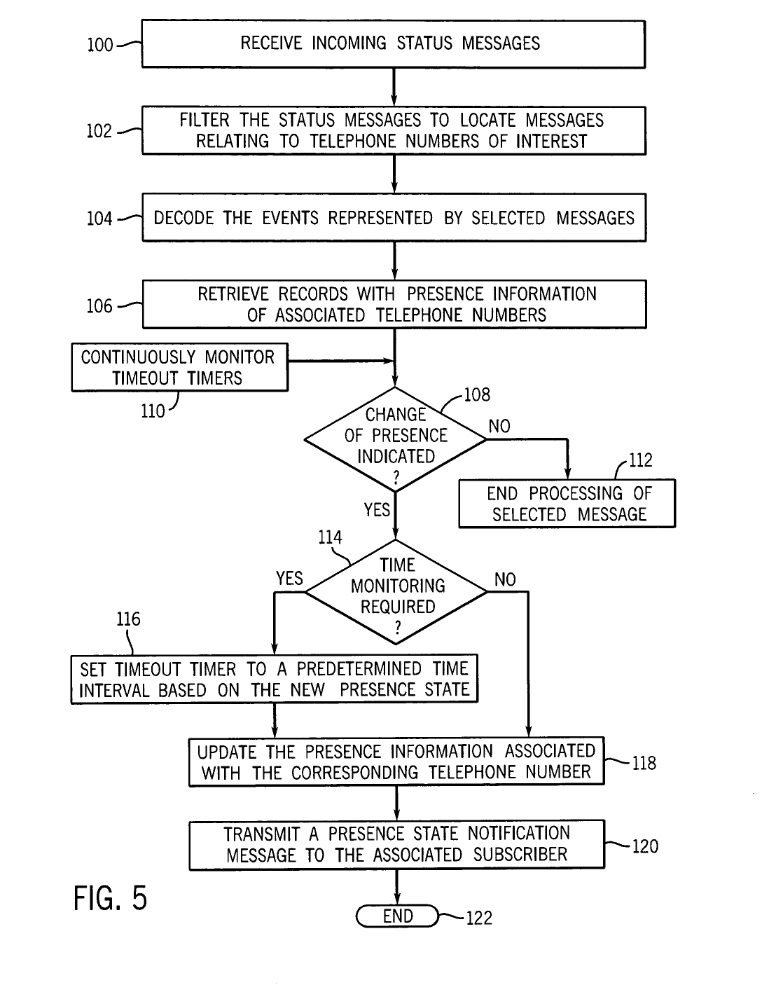

Before describing the method illustrated by FIG. 5, it will be helpful to understand some aspects of the call model implemented by the switches 16 and 22. Those skilled in the art will appreciate that each PSTN telecommunication origination/termination switch must determine certain basic conditions associated with each supported telephone line in order process call originations and incoming calls. Although numerous call states and conditions/events are determined by the switches, the following events are offered by way of example to illustrate how presence of PSTN lines can be determined. With regard to a call origination at a switch, the switch must receive an origination attempt authorization (OAA) in order to permit processing of a call origination. Following the origination of a call at an originating switch, an origination disconnect (OD) event is generated to signify that the call is over and that the telephone line should be released. At a terminating switch which processes an incoming call to a subscriber line, a termination authorization (TA) is generated to signify that the associated telephone line is authorized to receive the incoming call. At the conclusion of the telephone call, a termination disconnect (TD) is generated to indicate that the telephone line should be released. These four events can be used as the basis for determining presence of a PSTN wireline or wireless subscriber. In addition for wireless subscribers, an active registration in the subscriber's HLR can be utilized to determine that the corresponding subscriber is available for communications.

FIG. 5 illustrates an exemplary flow diagram of steps implemented by the intelligent node 32 in accordance with an embodiment of the present invention. In step 100 the intelligent node 32 receives incoming status messages from switches 16 and 22, and HLR 30 corresponding to events associated with activity on selected PSTN telephone lines and wireless telephones. In order to obtain the PSTN presence service, Internet users will have previously subscribed for this service, i.e. Internet users will have subscribed for this service with the service provider furnishing presence service and will have input a list of the PSTN telephone numbers corresponding to members of their Pal list. The intelligent node 32 stores records in its associated database 34 to maintain a current listing of authorized Internet subscribers that includes their Internet addresses and a list of PSTN Pals (telephone numbers) for which the Internet subscriber desires presence information. The presence server 46 utilizes the dynamic trigger detection mode capability of the SCP 48 to detect call events, such as OAA, OD, TA, TD events, from the switches 16 and 22 for specific PSTN telephone lines for which presence status is sought. The SCP relays this information about call events to the presence server.

In step 102 the intelligent node 32 filters the status messages to locate status messages relating to the specific telephone numbers (Pals) of interest to the subscribed Internet users. In step 104 the intelligent node 32 decodes the events represented by the selected status messages. In step 106 records with prior presence information are retrieved for the associated telephone numbers of interest. In step 108 a determination is made of whether a change of presence is indicated for the selected telephone line. The intelligent node 32 stores events previously received with regard to a telephone line of interest so that new events can be compared with the previous event in order to make a determination with regard to presence. For example, an OAA event will typically signify the beginning of a telephone call for the associated telephone line. The receipt of a next OD event for the same telephone line will typically indicate termination of the previously originated telephone call. Assuming that the Pal of interest originated the call from the specified telephone line, an assumption can be made that for at least a predetermined interval of time the Pal is still available for communications by the telephone line. Similarly, the receipt of a TD event following a previous TA event on the same telephone line will normally indicate the end of an incoming telephone call; this can be the basis of an assumption that the Pal associated with the telephone line will still be available for communications for at least a predetermined interval of time. As will be explained below, timeout timers are continuously monitored in step 110 to determine if a timeout interval initiated by a prior call event has been reached. The reaching of a timeout interval generates an event that is input to step 108 which is also utilized to determine if a change of presence is indicated.

A NO determination by step 108 results in the processing of the selected message/event being terminated. That is, a determination is made that no change of presence is required. A YES determination by step 108 results in a further determination at step 114 of whether time monitoring is required. In accordance with an exemplary method of the present invention, time monitoring by a timeout timer will be initiated upon the detection of an event signifying the end of a telephone call for a telephone line of interest. A YES determination by step 114 results in a timeout timer being set to a predetermined time interval based on the new presence state as indicated at step 116. The predetermined time interval corresponds to the time during which the associated Pal is assumed to be available for communications following the conclusion of a telephone call. The predetermined time interval can represent a fixed value, e.g. 5-30 minutes, utilized for all PSTN telephone lines. Alternatively the predetermined time interval can be a dynamically determined value based on heuristics associated with individual telephone lines in order to account for differences in the habits of the respective Pals.

A NO determination by step 114 indicates that time monitoring is not required. For example, if the event that caused the change of presence was the registration of a cellular telephone for the selected Pal, one might choose to make the assumption that the associated Pal has an available presence as long as the cellular telephone is ON and registered. Thus, such an event would not require time monitoring by the setting of a timeout timer.

Step 118 is executed following step 116 as well as a NO determination by step 114. In step 118 the presence information associated with the corresponding telephone number is updated and stored in the corresponding record in database 34. In step 120 a presence state notification message is transmitted to the associated Internet subscriber in view of a change of presence being indicated. The processing terminates at End 122.

FIG. 6 illustrates steps in an exemplary method implemented by the Internet user's communication terminal to provide presence information in accordance with an embodiment of the present invention. It is assumed that the Internet user's communication terminal includes an appropriate operating system and application programs required order to conduct two-way communications and services associated with such standard communications. The steps represented in FIG. 6 reflect an additional application program (or modifications made to an existing application) to be implemented on the basic system of the communication terminal. In step 150 the Internet user's communication terminal receives a presence state notification message generated by the intelligent node 32. Preferably this notification message will be transmitted as a packet using a standard Internet protocol compatible with the communication terminal. The presence state notification message preferably includes identification of the associated Pal (by name and/or telephone number), the presence state of the associated Pal, and may contain additional information that could be relevant to the Internet user with regard to a presence determination such as the time an event occurred or a predetermined time interval having elapsed.

In step 152 the presence state notification message is decoded to determine the corresponding telephone number/Pal and associated presence state and other additional information. This information is preferably stored in memory at the Internet user's terminal equipment. In step 154 a determination is made of the appropriate visual indicia to be displayed in the left column of the row corresponding to the Pal based on the presence state as received in the notification message. In step 156 instructions are provided to the screen display causing it to display the selected visual indicia in association with the corresponding Pal. This process concludes at End 158.

Although an embodiment of the present invention has been described and shown in the drawings, will be apparent to those skilled in the art that various changes and modifications to the specific embodiment can be made to achieve the same or similar benefits. The present invention contemplates within its scope the changes and modifications described below, and other changes and modifications that are equivalents or alternatives for accomplishing the same or similar benefits. For example, the intelligent node 32 of FIG. 1 may consist of a stand-alone server that does not utilize an SCP 48 as shown in FIG. 2. Such a stand-alone server would directly receive the event messages transmitted from the switches 16 and 22, and would filter the received messages to accept only those messages associated with selected telephone numbers of interest to the subscribed Internet users. Depending upon the ability of the switches to interface with intelligent peripherals, the switches may send messages associated with events for all supported telephone lines or may only transmit event messages for the telephone numbers of interest. For the latter situation, the stand-alone server would not be required to filter the incoming event messages since only those messages of interest would be transmitted from the switches. Such a stand-alone server would also store in memory a history of event messages so that a current presence state can be determined by comparing the most recent call event to previous call events for the same telephone number. Records are preferably stored in a manner so that each record can be updated based on a call event associated with a specific telephone number.

In a further alternative arrangement, the switches 16 and 22 could be modified to integrate the functions provided by the intelligent node 32 so that a physically separate intelligent node would not be required. Obviously the switches contain call event information relating to supported telephone lines. Assuming that sufficient computing power/processing time is available at the switch, the additional filtering, presence determining and Internet message sending functions could be incorporated.

In the embodiment explained with regard to FIG. 5, the change of presence decision and timeout timing function are performed by the intelligent node 32. One or both of these functions could be distributed and incorporated into the Internet user's terminal devices depending on the bandwidth available for the transmission of call event messages and the computing resources available at the terminal devices. For example, the intelligent node 32 could function as merely a filter that identifies the specific telephone number associated with the event messages received from the switches, and then transmits the event messages to the associated Internet subscriber. This would place the burden of making presence decisions based on such received event messages on each Internet subscriber's terminal equipment. Such an embodiment would offer Internet subscribers with the opportunity to obtain event messages from different system operators in the PSTN, i.e. from multiple intelligent nodes associated with each system operator, without requiring that all system operators interface with and utilize a single intelligent node. Such an embodiment would have the disadvantage of requiring greater transmission bandwidth to the Internet users.

The screen displays shown in FIGS. 3 and 4 are exemplary. It will be apparent to those skilled in the art that a variety of visual, audible or sensory indicia could be utilized to communicate the presence state of a Pal. For example, various symbols, letters, numbers, characters, outlines, colors, and patterns can be utilized as visual indicia. It should also be apparent that various techniques can be utilized to identify each Pal. In addition to utilizing a separate visual indicia in addition to the Pal identification, various types of fonts, styles and other visually distinguishing characteristics can be made directly to the Pal identification in order to convey a presence state of the Pal.

Although embodiments of the present invention have been described above and shown in the drawings, the scope of the invention is defined by the claims that follow.

1. A method for providing presence state information comprising the steps of:
receiving first messages from at least one switch in the public switched telephone network (PSTN) containing call event information for at least one telephone line among a plurality of telephone lines served by the one switch;
determining a presence state of a PSTN subscriber associated with the at least one telephone line;
transmitting a second message using Internet protocol to a first Internet terminal equipment of a first Internet user, the second message containing the presence state information associated with the at least one telephone line.

2. The method according to claim 1 further comprising the steps of determining a call state of the at least one telephone line based on the call event information contained within each of the first messages, and storing in memory at least the previous call state associated with the at least one telephone line.

3. The method according to claim 2 wherein the step of determining the presence state of the PSTN subscriber comprises comparing a current call state associated with the one telephone line with the stored previous call state associated with the at least one telephone line.

4. The method according to claim 1 further comprising the steps of receiving the second message at the first Internet terminal equipment of the first Internet user, determining a visual indicia corresponding to the presence state information contained in the second message, and displaying said visual indicia with a Pal identification label with which the visual indicia is associated.

5. The method according to claim 4 wherein the step of displaying further comprises the step of displaying time information as part of said visual indicia, where the time information is relevant to determining presence of the PSTN subscriber.

6. The method according to claim 5 wherein the step of displaying time information as part of said visual indicia comprises displaying the time of the last presence state change.

7. The method according to claim 5 wherein the step of displaying time information as part of said visual indicia comprises displaying the time within which the PSTN subscriber is determined to be available for communications.

8. The method according to claim 1 wherein the first messages received from the at least one switch are in a PSTN compatible protocol.

9. The method according to claim 1 wherein said first messages are originated by the at least one switch in the PSTN.

10. The method according to claim 1 wherein the step of transmitting the second message comprises transmitting second messages containing the presence state information associated with the at least one telephone line, wherein the presence state information includes time information.

11. The method according to claim 10 wherein the time information comprises a time when said call event occurred.

12. The method according to claim 10 wherein the time information comprises a determined time interval following the occurrence of the call event during which the PSTN subscriber is defined to be available for communications.

13. The method according to claim 1 wherein the at least one telephone line is connected to a PSTN terminal that is not capable of direct Internet communications.

14. A method for providing presence state information to an Internet user using an Internet terminal about a public switched telephone network (PSTN) subscriber utilizing a first terminal that does not have direct Internet communications capability, the method comprising the steps of:
receiving first messages from at least one switch in the PSTN containing call event information for at least a first telephone line coupled to the first terminal;
determining a presence state of the PSTN subscriber associated with the first telephone line;
transmitting a second message using Internet protocol to the Internet terminal of the Internet user, the second message containing the presence state information associated with the at least first telephone line.

15. The method according to claim 14 further comprising the steps of receiving the second message at the first Internet terminal of the Internet user, determining a visual indicia corresponding to the presence state information contained in the second message, and displaying said visual indicia representing the presence state on the Internet terminal with a Pal identification label with which the visual indicia is associated.

16. The method according to claim 15 further comprising the step of displaying time information as part of said visual indicia, where the time information is relevant to determining presence of the PSTN subscriber.

17. The method according to claim 15 further comprising the step of displaying one of a PSTN telephone number and a name of the party with whom the Pal is having a telephone call.

18. The method according to claim 5 further comprising the step of displaying one of a PSTN telephone number and a name of the party with whom the Pal is having a telephone call.
